(19) United States
(12) Patent Application Publication
(10) Pub. No.: US 2014/0372530 A1
(43) Pub. Date: Dec. 18, 2014

(54) METHOD AND SYSTEM TO UTILIZE BIO SMART SOCIAL NETWORKING ENVIRONMENT

(71) Applicant: Jawahar Jain, Los Altos, CA (US)

(72) Inventor: Jawahar Jain, Los Altos, CA (US)

(21) Appl. No.: 14/318,586

(22) Filed: Jun. 28, 2014

(51) Int. Cl. H04L 29/06

(52) U.S. Cl. CPC H04L 65/403
USPC 709/204

(57) ABSTRACT

The present disclosure provides a method and a system for managing a group of users in a bio-smart application. The method and system include fetching a plurality of pre-defined set of one or more biomarkers associated with each of one or more users dynamically through an associated communication device of each of one or more users at a pre-defined time intervals, enabling sharing of the pre-defined set of the one or more biomarkers by each of the one or more users through the associated communication device on a bio-smart social networking platform, facilitating chalking of a plurality of rules and one or more-predefined conditions within sets of the one or more users on the bio-smart social networking platform pertaining to the one or more bio-markers and licensing interaction between at least one or more sets of the one or more users and within the one or more users.

### TECHNICAL FIELD

The present disclosure relates to social networking applications and, in particular relates to, bio-smart social networking applications.

### BACKGROUND

In the present era of Internet, people communicate with each other through social networking websites. These social networking websites enable users to form groups with friends, colleagues and other people. In addition, these social networking websites allow the users to share their contact information, personal information, professional information, views, images and the like on the social networking websites. Moreover, these social networking websites allow the users to view and comment on information posted by other people in their contact list/social group. Further, the social networking websites provide various applications to the users including online game applications, educational applications, social applications and the like. Furthermore, the social networking websites allow the users to communicate with each other. Thus, the users can discuss their problems with one another and express their feelings to one another. Furthermore, the users can help each other to solve each other's problems.

Moreover, at times, people in the contact list/social group of the users may influence the users by affecting the mood of the users. For example, some people get relaxed/stressed out after talking to their friends while other people get stressed in the presence of some of the people in their contact list/social group. It is important for the users to determine whose presence affects them and how. Moreover, it is important for the users to analyze their mood (e.g., stressed, relaxed, happy, sad and the like), so that they can manage their behavior and improve their mood. Further, it is important for people suffering from anxiety, heart problems and the like to determine cause of their stress to control it. Furthermore, it is important for students to determine cause and level of their stress to relieve it during examination and the like. Thus, by determining cause and level of stress, the users can improve their psycho-physiological condition (e.g., mood, stress level and the like) and improve their health.

Sometimes, the users do not realize that they get affected in the presence of some of the people in their contact list/social group. However, it is important for users to know the people in their contact list/social group who affect them. There is no method and system available that communicates mood of the user in real time to other users in his contact list/social group. Moreover, there is no method and system available that enables the users in the contact list/social group of the user to know about the user's mood. Further, there is no method and system available that enables the users in the contact list/social group of the user to cooperate with the user to improve mood of the user. Furthermore, there is no method and system available that enables the user to help the users in his contact list/social group to improve their moods. Furthermore, there is no method and system available that enables the users to cooperate with each other for releasing each other's stress and develop healthy relations.

In view of the above stated discussion, there is a need for a method and system to overcome the above stated disadvantages/limitations. Moreover, the method and system should enable the users to achieve above stated goals efficiently.

### SUMMARY

The present disclosure provides a method and a system for managing a group of users in a bio-smart application. The methods and system include fetching a plurality of a pre-defined set of one or more biomarkers associated with each of one or more users dynamically through an associated communication device of each of one or more users at a pre-defined time intervals, enabling sharing of the pre-defined set of the one or more biomarkers by each of the one or more users through the associated communication device on a bio-smart social networking platform, facilitating chalking of a plurality of rules and one or more-predefined conditions within one or more sets of the one or more users on the bio-smart social networking platform pertaining to the one or more bio-markers and licensing interaction between at least one or more sets of the one or more users and within the one or more users. The plurality of rules and one or more-predefined conditions and interaction between at least one or more sets of the one or more users and within the one or more users enables management of the pre-defined set of the one or more biomarkers associated with the each of one or more sets of the one or more users on the bio-smart social networking platform. The one or more biomarkers may be computed from a single sensor or a plurality of sensors. Moreover, computations and analysis of the one or more biomarkers may be done utilizing present and/or past values collected by the plurality of sensors.

In an embodiment of the present disclosure, facilitating chalking of the plurality of rules and the one or more-predefined conditions comprises recognizing a set of the one or more users on the bio-smart social networking platform for contributing in accordance with the plurality of rules and one or more-predefined conditions within one or more sets of the one or more users on the bio-smart social networking platform.

In an embodiment of the present disclosure, facilitating chalking of the plurality of rules and the one or more-predefined conditions comprises recognizing one or more users on the bio-smart social networking platform for contributing in accordance with the plurality of rules and one or more-predefined conditions within one or more sets of the one or more users on the bio-smart social networking platform.

In an embodiment of the present disclosure, facilitating chalking of the plurality of rules and the one or more-predefined conditions comprises defining at least one of posting of content, one or more action points within the one or more sets of the one or more users, sequence of posting of content and sequence of posting of the one or more action points.

In an embodiment of the present disclosure, the pre-defined set of one or more biomarkers being fetched from a plurality of biosensors in contact with the user.

In an embodiment of the present disclosure, a first set of the plurality of biosensors being embedded in at least one of a wearable component. In an embodiment of the present disclosure, a first set of the plurality of biosensors being embedded in a wearable component and a communication device. In an embodiment of the present disclosure, a first set of the plurality of biosensors are on the body of user, wherein the first set of plurality of biosensors fetches a first set of the plurality of the pre-defined set of one or more biomarkers. The pre-defined set of biomarkers includes but may not be limited to heart rate factor, heart rate variability factor, galvanic skin response factor, breathing rate, and stress level.

In another aspect of the present disclosure, a system includes an input/output module configured to fetch a plurality of a pre-defined set of one or more biomarkers associated with each of one or more users dynamically through an associated communication device of each of one or more users at a pre-defined time intervals, a sharing module configured to share the pre-defined set of the one or more biomarkers by each of the one or more users through the associated communication device on a bio-smart social networking platform, facilitating module configured to facilitate chalking of a plurality of rules and one or more-predefined conditions within one or more sets of the one or more users on the bio-smart social networking platform pertaining to the one or more bio-markers and a licensing module configured to license interaction between at least one or more sets of the one or more users and within the one or more users. The plurality of rules and one or more-predefined conditions and interaction between at least one or more sets of the one or more users and within the one or more users enables management of the pre-defined set of the one or more biomarkers associated with the each of one or more sets of the one or more users on the bio-smart social networking platform.

In an embodiment of the present disclosure, facilitating chalking of the plurality of rules and the one or more-predefined conditions comprises recognizing a set of the one or more users on the bio-smart social networking platform for contributing in accordance with the plurality of rules and one or more-predefined conditions within one or more sets of the one or more users on the bio-smart social networking platform.

In an embodiment of the present disclosure, facilitating chalking of the plurality of rules and the one or more-predefined conditions comprises recognizing one or more users on the bio-smart social networking platform for contributing in accordance with the plurality of rules and one or more-predefined conditions within one or more sets of the one or more users on the bio-smart social networking platform.

In an embodiment of the present disclosure, facilitating chalking of the plurality of rules and the one or more-predefined conditions comprises defining at least one of posting of content, one or more action points within the one or more sets of the one or more users, sequence of posting of content and sequence of posting of the one or more action points.

In an embodiment of the present disclosure, the pre-defined set of one or more biomarkers being fetched from a plurality of biosensors in contact with the user.

In an embodiment of the present disclosure, a first set of the plurality of biosensors being embedded in at least one of a wearable component. In an embodiment of the present disclosure, a first set of the plurality of biosensors being embedded in a wearable component and a communication device. In an embodiment of the present disclosure, a first set of the plurality of biosensors are on the body of user, wherein the first set of plurality of biosensors fetches a first set of the plurality of the pre-defined set of one or more biomarkers. The pre-defined set of biomarkers includes but may not be limited to heart rate factor, heart rate variability factor, galvanic skin response factor, breathing rate, breathing effort, and stress level.

In yet another aspect, a computer system includes one or more processors and a non-transitory memory containing instructions that, when executed by the one or more processors, causes the one or more processors to perform a set of steps. The set of steps include fetching, by an input/output module, a plurality of a pre-defined set of one or more biomarkers associated with each of one or more users dynamically through an associated communication device of each of one or more users at a pre-defined time intervals, enabling, by a sharing module, an input/output module sharing of the pre-defined set of the one or more biomarkers by each of the one or more users through the associated communication device on a bio-smart social networking platform, facilitating, by a facilitating module, chalking of a plurality of rules and one or more-predefined conditions within one or more sets of the one or more users on the bio-smart social networking platform pertaining to the one or more bio-markers and licensing, by a licensing module, interaction between at least one or more sets of the one or more users and within the one or more users. The plurality of rules and one or more-predefined conditions and interaction between at least one or more sets of the one or more users and within the one or more users enables management of the pre-defined set of the one or more biomarkers associated with the each of one or more sets of the one or more users on the bio-smart social networking platform.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a social networking environment, wherein various embodiments of the present disclosure can be practiced;

FIG. 2 illustrates an example embodiment to implement bio-smart social networking, in accordance with various embodiments of the present disclosure;

FIG. 3 illustrates a block diagram of the bio-smart social networking server, in accordance with various embodiments of the present disclosure;

FIG. 4 illustrates a flowchart for managing biomarkers of the users using the bio-smart social networking server, in accordance with various embodiments of the present disclosure;

FIG. 5 illustrates a flowchart for managing biomarkers of the usersusing the bio-smart social networking server, in accordance with another embodiment of the present disclosure;

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

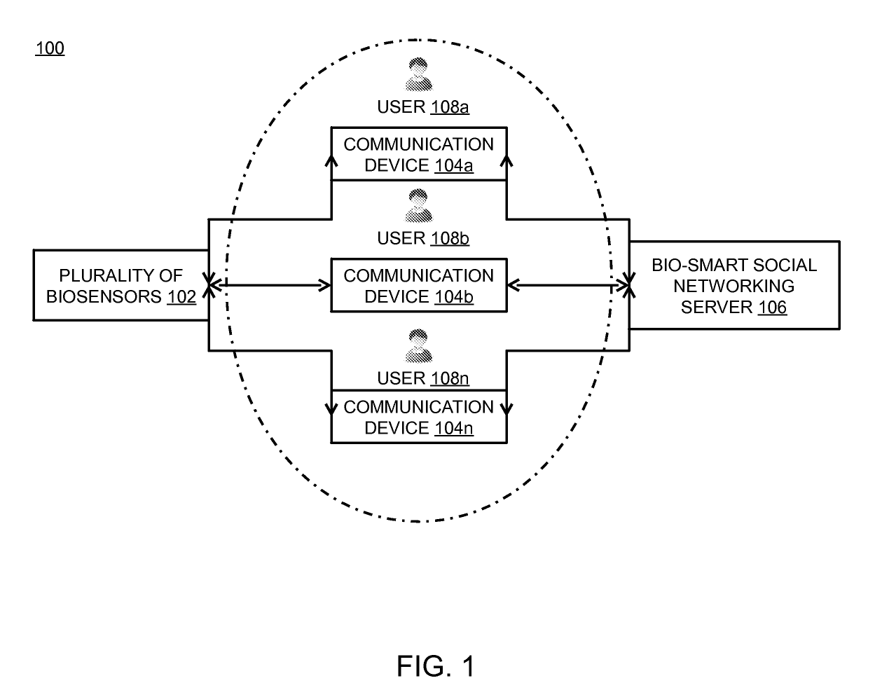

FIG. 1 illustrates a social networking environment 100, wherein various embodiments of the present disclosure can be practiced. The social networking environment 100 includes plurality of biosensors 102, communication devices 104a-n associated with users 108a-n and a bio-smart social networking server 106. The plurality of biosensors 102 perform real-time measurement of human biomarkers (psycho-physiological measurements) including heart rate measurement, breathing rate measurement, galvanic skin response and the like. The plurality of biosensors 102 may be embedded in wearable devices (for e.g. belts, smart watches, rings, ear plugs and the like) or other devices that can receive the human biomarkers. Moreover, the plurality of biosensors 102 communicate with the communication devices 104a-n associated with the users 108a-n using one or more of Internet, Intranet, virtual private network, LAN, Wifi, bluetooth and the like. The plurality of biosensors 102 may include sensors present in mobile phones, smart devices, laptops and the like. Each of the communication devices 104a-n interacts with the bio-smart social networking server 106 to determine level of stress associated with the users 108a-n having the communication devices 104a-n.

The communication devices 104a-n include personal computers, laptops, personal digital assistants, tablets, phablets, webpads, wearable computers, mobile telephones, wrist-worn computers, smart phones, smart TVs, or any other device capable of displaying a web-based interface. Moreover, the bio-smart social networking server 106 provides a web based application to the communication devices 104a-n.

Those skilled in the art would appreciate that the present disclosure is not limited to the biomarkers mentioned above but to the biomarkers which can be measured by the technologies presently known in the art.

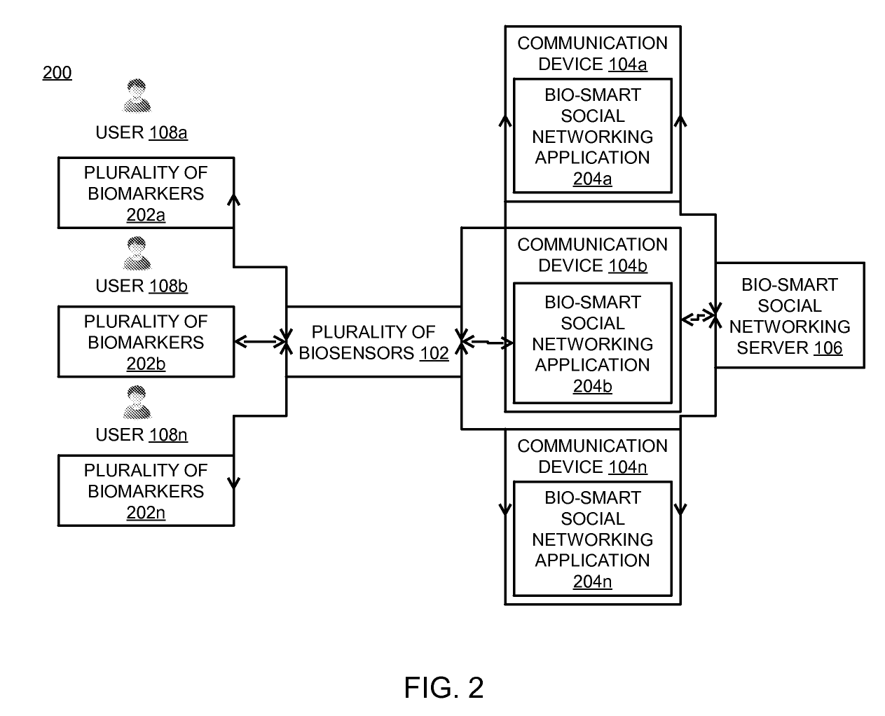

FIG. 2 illustrates an examplary embodiment to implement bio-smart social networking, in accordance with various embodiments of the present disclosure. It may be noted that references will be made to various elements of FIG. 1 to explain the exemplary embodiment of FIG. 2.

As mentioned in description of FIG. 1, the system includes a plurality of biomarkers 202a-n associated with the users 108a-n. The plurality of biomarkers 202a-n indicate physiological impact of psychological processes on the users 108a-n. The plurality of biomarkers 202a-n associated with the users 108a-n include heart activity, brain activity, skin activity, muscle activity and the like. For example, the plurality of biomarkers 202a-n associated with a user U can be oxygen saturation, heart rate, electro-cardiography (electrical activity of heart or ECG), respiration rate and the like of the user U. The plurality of biosensors 102 measure the plurality of biomarkers 202a-n associated with the users 108a-n. In addition, the bio-smart social networking server 106 provides bio-smart social networking applications 204a-n on the communication devices 104a-n of the users 108a-n to monitor and control the plurality of biomarkers 202a-n associated with the users 108a-n. The bio-smart social networking application 204a-n may be a social networking application that is configured to be bio-smart. Thus, along with sharing of profile, status information, contact information, messages, biological parameters (plurality of biomarkers 202a-n) and the like among each other, the bio-smart social networking application 204a-n enables the users 108a-n to receive and control biological parameters (the plurality of biomarkers 202a-n) of the users 108a-n.

It may be noted that the plurality of biosensors 102, as described above, for measuring the plurality of biomarkers 202a-n associated with the users 108a-n are biological sensors; however those skilled in the art would appreciate that the plurality of biosensors 102 may include bio-sensors present in mobile devices (for e.g. laptops, mobile phones and the like), wearable communication devices (for e.g. smart watches, rings and the like) and the like.

In an embodiment of the present disclosure, the bio-smart social networking application 204a-n displays a stress profile, corresponding to a consolidated report generated from the plurality of biomarkers 202a-n of the users 108a-n, on the communication devices 104a-n of the users 108a-n.

In another embodiment of the present disclosure, the bio-smart social networking application 204a-n displays a relative stress profile, corresponding to a consolidated report generated after comparing the plurality of biomarkers 202a-n of the users 108a-n with each other, on the communication devices 104a-n of each of the users 108a-n. The relative stress profile of each of the users 108a-n indicates impact of other users on the plurality of biomarkers 202a-n of each of the users 108a-n. For example, if there are four users, say A, B, C and D in a social group, then relative stress profile of the user A indicates impact of the users B, C and D on biomarkers of the user A. Moreover, the bio-smart social networking application associated with the user A displays a relative stress profile on display of a communication device associated with the user A corresponding to each of the user B, C and D.

In yet another embodiment of the present disclosure, the users 108a-n may share their stress profiles and relative stress profiles with one another in their social group. Thus, the users 108a-n may determine psycho-physiological condition of each other in the social group and may help each other to improve the stress profile and the relative stress profile and hence the plurality of biomarkers 202a-n. For example, if the users B, C and D determine that stress profile of the user A is not normal, then the user B, C and D may help the user A to release stress and improve the biomarkers.

In yet another embodiment of the present disclosure, the bio-smart social networking server 106 enables the users 108a-n of the bio-smart social networking application 204a-n to play a team building game/health game based on the plurality of biomarkers 202a-n associated with the users 108a-n. The team building game/health game may be played between two or more teams and each team may include two or more users. Moreover, the team building game/health game may provide some incentives in form of awards for the winning team. In the team building game/health game, the stress profile and the relative stress profile of each of the user in a team are visible to all the users in that team. Further, the team building game/health game may provide a target to the teams competing with each other. The target may be based on some pre-defined set of rules and pre-defined set of parameters for the plurality of biomarkers 202a-n. The target may be defined to bring a collective stress profiles of all the users in a team in some pre-defined range based on the pre-defined set of parameters. For example, a target can be of form: heart rate<x, breathing rate>y and galvanic skin response>z. Moreover, a rule can be form: zone 1 for team in which users spend up to 10 minutes to achieve the group target, zone 2 for team in which users spend up to 20 minutes to achieve the group target and zone 3 for team in which users spend more than 20 minutes. Thus, all the users in each of the participating teams communicate with each of the members in their respective teams in a systematic manner and try to achieve the target for the team collectively. The team that achieves the target or has overall better biomarkers (for example, reduced stress, normal heart rate and the like) wins the team building game/health game. The winning team may be provided with incentives. Moreover, by communicating with each other for achieving group target, all the users develop team spirit and healthy relationship is established among them. It may be noted that the target and the rule defined above may be modified in any respect to define various aspects for winning the team building game/health game. Moreover, the team building game/health game may be modified for various applications including team building in corporate environment, relationship building in families and the like.

In yet another embodiment of the present disclosure, the bio-smart social networking server 106 may be configured to define different rule and different target for the users 108a-n. However, each of the users 108a-n must communicate with each other in their respective teams. Moreover, the users of competing teams may communicate with each other. For example, if team T1 and team T2 are competitors, then users of the bio-smart social networking server 106 in the team T1 may communicate with the users of the bio-smart social networking server 106 in the team T2. Thus, by communicating with one another, each of the users 108a-n of the bio-smart social networking server 106 can analyse their behaviour and modulate their behaviour. For example, in order to achieve group target, each of the users belonging to a team strive to improve their stress profile and hence improve their behaviour. In yet another embodiment of the present disclosure, one or more users who have contributed the most is recognized and awarded.

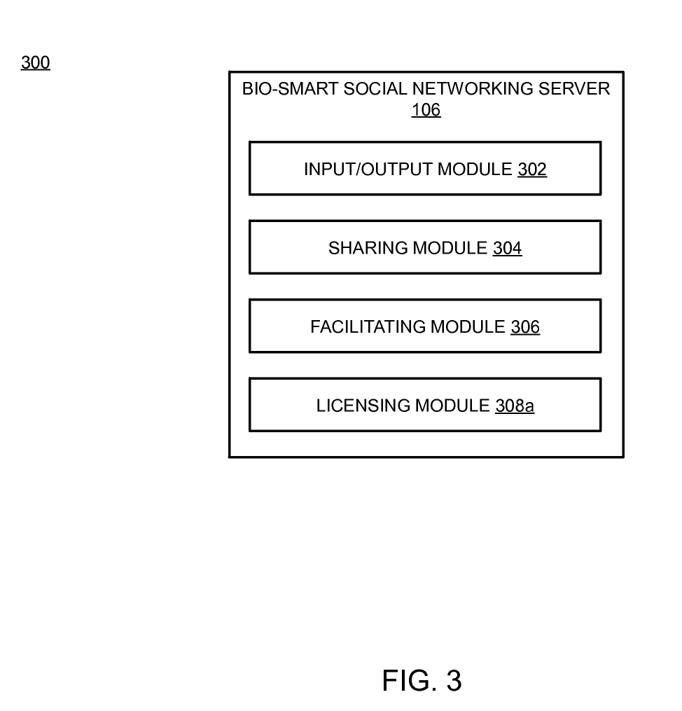

FIG. 3 illustrates a block diagram 300 of the bio-smart social networking server 106, in accordance with an embodiment of the present disclosure. The bio-smart social networking server 106 includes an input/output module 302, a sharing module 304, a facilitating module 306 and a licensing module 308. The input/output module 302 fetches a plurality of a pre-defined set of one or more biomarkers (the plurality of biomarkers 202a-n) associated with each of one or more users (the users 108a-n) dynamically through an associated communication device (the communication device 104a-n) of each of one or more users at a pre-defined time intervals. The input/output module 302 may be provided as components of the plurality of biosensors 102 or components present in the bio-smart social networking server 106 that receives the plurality of biomarkers 202a-n/biological inputs from the plurality of biosensors 102. The sharing module 304 shares the pre-defined set of the one or more biomarkers (the plurality of biomarkers 202a-n) by each of the one or more users (the users 108a-n) through said associated communication device on a bio-smart social networking platform. The facilitating module 306 facilitates chalking of a plurality of rules and one or more-predefined conditions within one or more sets of the one or more users (the users 108a-n) on the bio-smart social networking platform pertaining to the one or more bio-markers (the plurality of biomarkers 202a-n). The licensing module 308 licenses interaction between at least one or more sets of the one or more users and within the one or more users. The plurality of rules and the one or more-predefined conditions and interaction between at least one or more sets of the one or more users and within the one or more users enables management of the pre-defined set of the one or more biomarkers (the plurality of biomarkers 202a-n) associated with each of the one or more sets of the one or more users on the bio-smart social networking platform.

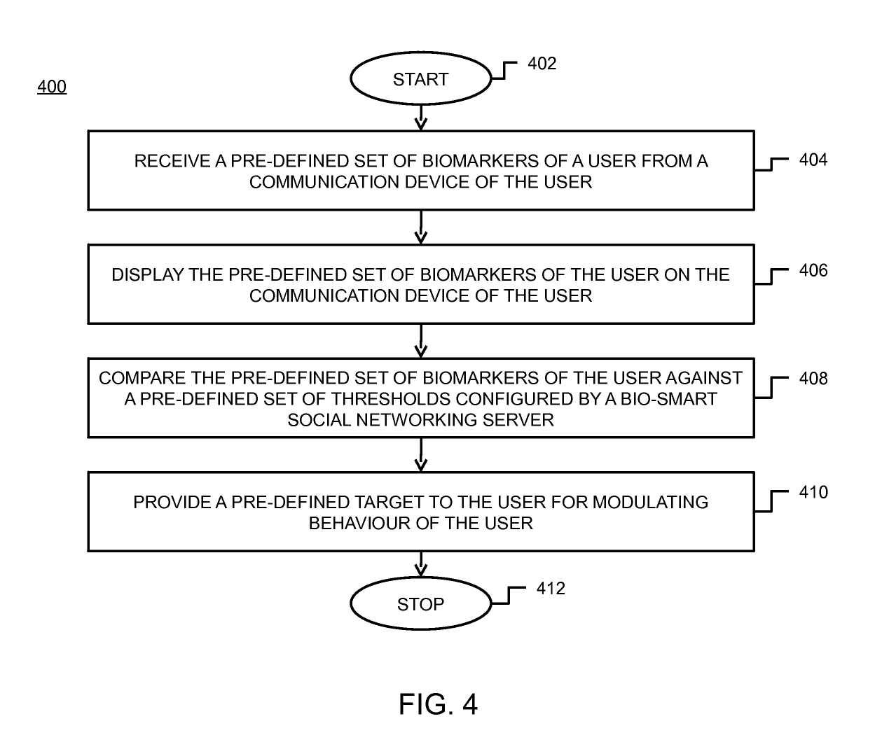

FIG. 4 illustrates a flowchart 400 for managing biomarkers of the users 108a-n using the bio-smart social networking server 106, in accordance with an embodiment of the present disclosure. The flowchart initiates at a step 402. At step 404, the bio-smart social networking server 106 enables receiving of a pre-defined set of biomarkers (the plurality of biomarkers 202a-n) of the users 108a-n from the communication devices 104a-n of the users 108a-n. The communication devices 104a-n receive the pre-defined set of biomarkers of the users 108a-n from the plurality of biosensors 102. Following the step 404, at a step 406, the bio-smart social networking server 106 enables displaying of the pre-defined set of biomarkers of the users 108a-n on the communication devices 104a-n of the users 108a-n. Following the step 406, at a step 408, the bio-smart social networking server 106 enables comparing of the pre-defined set of biomarkers of the users 108a-n against a pre-defined set of thresholds configured by the bio-smart social networking server 106. Following the step 408, at a step 410, the bio-smart social networking server 106 enables providing of a pre-defined target to the users 108a-n for modulating behavior of the users 108a-n. The flowchart terminates at a step 412.

In an embodiment of the present disclosure, the bio-smart social networking server 106 enables the users 108a-n to share the plurality of biomarkers 202a-n with one another. However, the users in one team may or may not share their collective stress profile and/or the plurality of biomarkers 202a-n with the users in competing team.

In another embodiment of the present disclosure, the bio-smart social networking server 106 enables logging of performance of the users 108a-n for all rounds of the team building game/health game. Moreover, in each successive round, every participating team is expected to perform better than the previous round. Further, the bio-smart social networking server 106 may be configured to continuously analyze performance of all the teams in all the rounds of the team building game/health game. Furthermore, the bio-smart social networking server 106 may define a threshold for stability and continuously analyze the performance of each team against the pre-defined threshold. When a team achieves the pre-defined threshold, the bio-smart social networking server 106 may infer that team building is reached. The concept may apply to any type of biomarker communication. Furthermore, logging of historical profile enables computing, storing and informing the users 108a-n about evolution of their respective biomarkers over time by interacting with other users in social groups.

In another embodiment of the present disclosure, the bio-smart social networking server 106 enables storing of the plurality of biomarkers 202a-n of the users 108a-n in a transient or non-transient memory of at least one of the communication devices 104a-n and the bio-smart social networking server 106.

In yet another embodiment of the present disclosure, the bio-smart social networking server 106 displays the plurality of biomarkers 202a-n corresponding to each of the users 108a-n (for example, the relative stress profile) of the bio-smart social networking application 204a-n on the communication devices 104a-n of the users 108a-n.

In yet another embodiment of the present disclosure, the bio-smart social networking server 106 displaying the plurality of biomarkers 202a-n against each of the users 108a-n of the bio-smart social networking application 204a-n indicates an impact of each of the users 108a-n on the plurality of biomarkers 202a-n of one another. In an embodiment of the present disclosure, each of the users in a group has to interact in some systematic manner (example, round robin fashion).

In yet another embodiment of the present disclosure, the bio-smart social networking server 106 displays the plurality of biomarkers 202a-n against each of the users 108a-n of the bio-smart social networking application 204a-n when each of the users 108a-n enter the bio-smart social networking application server 106 using the communication devices 104a-n.

In yet another embodiment of the present disclosure, the bio-smart social networking server 106 displays the plurality of biomarkers 202a-n against each of the users 108a-n of the bio-smart social networking application 204a-n when each of the users 108a-n leave the bio-smart social networking application server 106.

In yet another embodiment of the present disclosure, the bio-smart social networking server 106 displays the plurality of biomarkers 202a-n against each of the users 108a-n of the bio-smart social networking application 204a-n at a pre-defined time interval when each of the users 108a-n remain in the bio-smart social networking application server 106.

In yet another embodiment of the present disclosure, the bio-smart social networking server 106 displaying the plurality of biomarkers 202a-n against each of the users 108a-n of the bio-smart social networking application 204a-n indicates an impact of each of the users 108a-n on the plurality of the biomarkers 202a-n of one another.

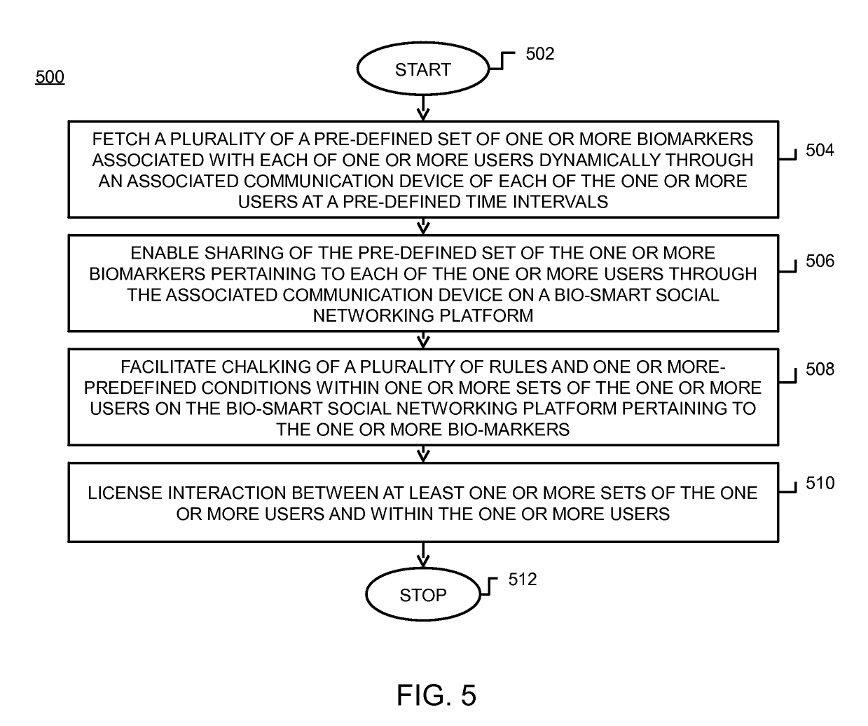

FIG. 5 illustrates a flowchart 500 for managing biomarkers of the users 108a-n using the bio-smart social networking server 106, in accordance with various embodiments of the present disclosure. The flowchart initiates at a step 502. At step 504, the bio-smart social networking server 106 fetches plurality of a pre-defined set of one or more biomarkers associated with each of one or more users (the users 108a-n) dynamically through an associated communication device of each of one or more users at a pre-defined time intervals. Following the step 504, at step 506, the bio-smart social networking server 106 enables sharing of the pre-defined set of the one or more biomarkers by each of the one or more users through the associated communication device on the bio-smart social networking platform. Following the step 506, at step 508, the bio-smart social networking server 106 facilitates chalking of a plurality of rules and one or more-predefined conditions within one or more sets of the one or more users on the bio-smart social networking platform pertaining to the one or more bio-markers. Following the step 508, at step 510, the bio-smart social networking server 106 licenses interaction between at least one or more sets of the one or more users and within the one or more users. The plurality of rules and one or more-predefined conditions and interaction between at least one or more sets of the one or more users and within the one or more users enables management of the pre-defined set of the one or more biomarkers associated with the each of one or more sets of the one or more users on the bio-smart social networking platform.

FIG. 6 illustrates a block diagram 600 of a dedicated computer 602 that acts as the server 106, in accordance with various embodiments of the present disclosure. It may be noted that to explain the block diagram 600 of the dedicated computer 602 that acts as the server 106, references will be made to the various elements of the system 100 and the block diagram 200.

The dedicated computer 602 includes but may not be limited to a control circuitry 604, storage 606, an input/output circuitry 608, and a communication circuitry 610.

From the perspective of this disclosure, the control circuitry 604 includes any processing circuitry or processor operative to control the operations and performance of the dedicated computer 602. For example, the control circuitry 604 may be used to run operating system applications, firmware applications, media playback applications, media editing applications, or any other application. In an embodiment, the control circuitry 604 drives a display and process inputs received from a user interface.

From the perspective of this disclosure, the storage 606 includes one or more storage mediums including a hard-drive, solid state drive, flash memory, permanent memory such as ROM, any other suitable type of storage component, or any combination thereof. The Storage 606 may store, for example, media data (e.g., music and video files), application data (e.g., for implementing functions on the dedicated computer 602).

From the perspective of this disclosure, the I/O circuitry 608 may be operative to convert (and encode/decode, if necessary) analog signals and other signals into digital data. In an embodiment, the I/O circuitry 608 may also convert digital data into any other type of signal, and vice-versa. For example, the I/O circuitry 608 may receive and convert physical contact inputs (e.g., from a multi-touch screen), physical movements (e.g., from a mouse or sensor), analog audio signals (e.g., from a microphone), or any other input. The digital data may be provided to and received from the control circuitry 604, the storage 606, or any other component of the dedicated computer 602.

It may be noted that the I/O circuitry 608 is illustrated in FIG. 3 as a single component of the dedicated computer 602; however those skilled in the art would appreciate that several instances of the I/O circuitry 608 may be included in the dedicated computer 602.

The dedicated computer 602 may include any suitable interface or component for allowing a user to provide inputs to the I/O circuitry 608. The dedicated computer 602 may include any suitable input mechanism. Examples of the input mechanism include but may not be limited to a button, keypad, dial, a click wheel, gesture interprators, and a touch screen. In an embodiment of the present disclosure, the dedicated computer 602 may include a capacitive sensing mechanism, or a multi-touch capacitive sensing mechanism.

In an embodiment, the dedicated computer 602 may include specialized output circuitry associated with output devices such as, for example, one or more audio outputs. The audio output may include one or more speakers built into the dedicated computer 602, or an audio component that may be remotely coupled to the dedicated computer 602.

The one or more speakers can be mono speakers, stereo speakers, or a combination of both. The audio component can be a headset, headphones or ear buds that may be coupled to communications device with a wire or wirelessly.

In an embodiment, the I/O circuitry 608 may include display circuitry for providing a display visible to the user. For example, the display circuitry may include a screen (e.g., an LCD screen) that is incorporated in the dedicated computer 602.

The display circuitry may include a movable display or a projecting system for providing a display of content on a surface remote from the dedicated computer 602 (e.g., a video projector). In an embodiment, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry 604. Alternatively, the display circuitry may be operative to provide instructions to a remote display.

From the prospective of this disclosure, the communications circuitry 610 may include any suitable communications circuitry operative to connect to a communications network and to transmit communications (e.g., voice or data) from the dedicated computer 602 to other devices within the communications network. The communications circuitry 610 may be operative to interface with the communications network using any suitable communications protocol. Examples of the communications protocol include but may not be limited to Wi-Fi, Bluetooth, RTM, radio frequency systems, infrared, LTE, GSM, GSM plus EDGE, CDMA, and quadband.

In an embodiment of the present disclosure, the same instance of the communications circuitry 610 may be operative to provide for communications over several communications networks. In an embodiment of the present disclosure, the dedicated computer 602 may be coupled a host device for data transfers, synching the communications device, software or firmware updates, providing performance information to a remote source (e.g., providing riding characteristics to a remote server) or performing any other suitable operation that may require the dedicated computer 602 to be coupled to a host device. Several computing devices may be coupled to a single host device using the host device as a server. Alternatively or additionally, the dedicated computer 602 may be coupled to several host devices (e.g., for each of the plurality of the host devices to serve as a backup for data stored in the dedicated computer 602).

The foregoing descriptions, of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method comprising:
fetching a plurality of a pre-defined set of one or more biomarkers associated with each of one or more users dynamically through an associated communication device of each of one or more users at a pre-defined time intervals;
enabling sharing of said pre-defined set of said one or more biomarkers pertaining to each of said one or more users through said associated communication device on a bio-smart social networking platform;
facilitating chalking of a plurality of rules and one or more-predefined conditions within one or more sets of said one or more users on said bio-smart social networking platform pertaining to said one or more bio-markers; and
licensing interaction between at least one or more sets of said one or more users and within said one or more users, wherein said plurality of rules and one or more-predefined conditions and interaction between at least one or more sets of said one or more users and within said one or more users enables management of said pre-defined set of said one or more biomarkers associated with said each of one or more sets of said one or more users on said bio-smart social networking platform.

2. The method as recited in claim 1, wherein said facilitating chalking of said plurality of rules and said one or more-predefined conditions comprises recognizing a set of said one or more users on said bio-smart social networking platform for contributing in accordance with said plurality of rules and one or more-predefined conditions within one or more sets of said one or more users on said bio-smart social networking platform.

3. The method as recited in claim 1, wherein said facilitating chalking of said plurality of rules and said one or more-predefined conditions comprises recognizing one or more users on said bio-smart social networking platform for contributing in accordance with said plurality of rules and one or more-predefined conditions within one or more sets of said one or more users on said bio-smart social networking platform.

4. The method as recited in claim 1, wherein said facilitating chalking of said plurality of rules and said one or more-predefined conditions comprises defining at least one of posting of content, one or more action points within said one or more sets of said one or more users, sequence of posting of content and sequence of posting of said one or more action points.

5. The method as recited in claim 1, wherein said pre-defined set of one or more biomarkers being fetched from a plurality of biosensors in contact with said user.

6. The method as recited in claim 5, wherein a first set of said plurality of biosensors being embedded in at least one of a wearable component,

7. The method as recited in claim 5, wherein a first set of said plurality of biosensors being embedded in a wearable component and a communication device.

8. The method as recited in claim 5, wherein a first set of said plurality of biosensors are on the body of user, wherein said first set of plurality of biosensors fetches a first set of said plurality of said pre-defined set of one or more biomarkers.

9. The system as recited in claim 1, wherein said pre-defined set of biomarkers comprises at least one of heart rate factor, heart rate variability, galvanic skin response, breathing rate, breathing effort, stress level, relaxation level, blood pressure, stroke volume, peripheral blood flow, and pupil dilation.

10. A system comprising:
an input/output module configured to fetch a plurality of a pre-defined set of one or more biomarkers associated with each of one or more users dynamically through an associated communication device of each of one or more users at a pre-defined time intervals;
a sharing module configured to share said pre-defined set of said one or more biomarkers by each of said one or more users through said associated communication device on a bio-smart social networking platform;
a facilitating module configured to facilitate chalking of a plurality of rules and one or more-predefined conditions within one or more sets of said one or more users on said bio-smart social networking platform pertaining to said one or more bio-markers; and
a licensing module configured to license interaction between at least one or more sets of said one or more users and within said one or more users, wherein said plurality of rules and one or more-predefined conditions and interaction between at least one or more sets of said one or more users and within said one or more users enables management of said pre-defined set of said one or more biomarkers associated with said each of one or more sets of said one or more users on said bio-smart social networking platform.

11. The system as recited in claim 10, wherein said chalking of said plurality of rules and said one or more-predefined conditions comprises recognizing a set of said one or more users on said bio-smart social networking platform for contributing in accordance with said plurality of rules and one or more-predefined conditions within one or more sets of said one or more users on said bio-smart social networking platform.

12. The system as recited in claim 10, wherein said chalking of said plurality of rules and said one or more-predefined conditions comprises recognizing one or more users on said bio-smart social networking platform for contributing in accordance with said plurality of rules and one or more-predefined conditions within one or more sets of said one or more users on said bio-smart social networking platform.

13. The system as recited in claim 10, wherein said chalking of said plurality of rules and said one or more-predefined conditions comprises defining at least one of posting of content, one or more action points within said one or more sets of said one or more users, sequence of posting of content and sequence of posting of said one or more action points.

14. The system as recited in claim 10, wherein said pre-defined set of one or more biomarkers being fetched from a plurality of biosensors in contact with said user.

15. The system as recited in claim 14, wherein a first set of said plurality of biosensors being embedded in at least one of a wearable component.

16. The system as recited in claim 14, wherein a first set of said plurality of biosensors being embedded in a wearable component and a communication device.

17. The system as recited in claim 10, wherein a first set of said plurality of biosensors are on the body of user, wherein said first set of plurality of biosensors fetches a first set of said plurality of said pre-defined set of one or more biomarkers.

18. The system as recited in claim 10, wherein said pre-defined set of biomarkers comprises at least one of heart rate factor, heart rate variability factor, galvanic skin response factor, breathing rate and stress level.

19. A computer system comprising:
one or more processors; and
a non-transitory memory containing instructions that, when executed by said one or more processors, causes said one or more processors to perform a set of steps comprising:
fetching, by an input/output module, a plurality of a pre-defined set of one or more biomarkers associated with each of one or more users dynamically through an associated communication device of each of one or more users at a pre-defined time intervals;
enabling, by a sharing module, an input/output module sharing of said pre-defined set of said one or more biomarkers by each of said one or more users through said associated communication device on a bio-smart social networking platform;
facilitating, by a facilitating module, chalking of a plurality of rules and one or more-predefined conditions within one or more sets of said one or more users on said bio-smart social networking platform pertaining to said one or more bio-markers; and
licensing, by a licensing module, interaction between at least one or more sets of said one or more users and within said one or more users, wherein said plurality of rules and one or more-predefined conditions and interaction between at least one or more sets of said one or more users and within said one or more users enables management of said pre-defined set of said one or more biomarkers associated with said each of one or more sets of said one or more users on said bio-smart social networking platform.

20. The computer system as recited in claim 19, wherein said non-transitory memory containing instructions that, when executed by said one or more processors, cause said one or more processors to perform a further step of recognizing a set of said one or more users on said bio-smart social networking platform for contributing in accordance with said plurality of rules and one or more-predefined conditions within one or more sets of said one or more users on said bio-smart social networking platform.
